(19) United States
(12) Patent Application Publication
(10) Pub. No.: US 2008/0083161 A1
(43) Pub. Date: Apr. 10, 2008

(54) WEED BARRIER COMPRISING VEGETABLE PARCHMENT

(76) Inventor: Adam Shea, Huber Heights, OH (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/865,753

(22) Filed: Oct. 2, 2007

Related U.S. Application Data
(60) Provisional application No. 60/849,760, filed on Oct. 5, 2006.

(51) Int. Cl. A01G 7/00

(52) U.S. Cl. 47/9

(57) ABSTRACT

A weed barrier formed from a porous, biodegradable vegetable parchment is provided. The vegetable parchment may be placed in contact with soil and adjacent a plant or seedling to be cultivated. The parchment has a tensile strength of between about 15 to about 120 lbf/inch, a dry burst strength of between about 10 to about 90 lbs/sq. inch, and a wet burst strength of between about 4 to 60 lbs/sq. inch, which provides the necessary barrier to prevent growth of weeds through the parchment, while the porosity of the parchment allows both air and water to penetrate for proper growth of plants.

### CROSS-REFERENCE TO RELATED APPLICATIONS

This application claims the benefit of U.S. Provisional Application No. 60/849,760, filed Oct. 5, 2006, entitled USE OF VEGETABLE PARCHMENT AS A WEED BARRIER. The entire contents of said application are hereby incorporated by reference.

### BACKGROUND OF THE INVENTION

The present invention relates to the use of vegetable parchment as a barrier to weeds, and more particularly to a weed barrier which comprises porous, biodegradable vegetable parchment.

In agricultural production and landscaping applications, weeding is a time consuming but necessary process in order to ensure the health of growing seedlings and/or plants. Many substrates have been developed for placement over or around plants or seedlings in an effort to prevent the growth of weeds. For example, many farmers typically utilize a plastic film which covers an area of land and prevents the growth of weeds through the film. However, because the plastic film is not biodegradable, it must be gathered up when it is no longer needed and disposed of. In addition, the use of a plastic film results in poor water and air permeability and can have a negative effect on the growth of seedlings when the plastic film is used over the seedlings.

Accordingly, there is a need in the art for a substrate which can easily be placed around a variety of plants or seedlings, which acts as a weed barrier, which is biodegradable, and which provides sufficient porosity to allow air and water to penetrate through the substrate.

### SUMMARY OF THE INVENTION

The present invention meets those needs by providing a vegetable parchment product for use in weed control. Specifically, it has been found that the use of vegetable parchment functions as an effective weed barrier for use around potted plants, ornamental landscaping such as shrubs and flowers, and the like.

According to one aspect of the present invention, a weed barrier comprising a porous, biodegradable vegetable parchment is provided, where the parchment has a tensile strength of between about 15 to about 120 lbf/inch, a dry burst strength of between about 10 and about 90 lbs/sq. inch, and a wet burst strength of between about 4 and about 60 lbs/sq. inch. The vegetable parchment preferably has a basis weight of between about 20 to about 60 lb/3,000 sq. ft.

The vegetable parchment may used to control weed growth by placing the parchment in contact with soil and adjacent a plant or seedling to be cultivated such that the growth of weeds through the parchment paper is prevented or substantially reduced. In landscaping areas, the parchment is preferably placed between a layer of soil and a layer of mulch.

The vegetable parchment is preferably black in color, which effectively prevents new germination and weed growth in undesirable areas. The parchment is also hydroscopic (absorbent) in nature, so it aids in retaining moisture for the plants it is placed around.

The parchment preferably has a porosity of from about 60 to about 2000 seconds, which allows air and water to penetrate to the roots of the plants to be cultivated.

The parchment is biodegradable over time, i.e., the microbial activity within the soil/mulch degrades the parchment over time. Thus, the parchment is more environmentally friendly than many prior weed control substrates.

Accordingly, it is a feature of the invention to provide a method of weed control utilizing vegetable parchment. This, and other features and advantages will become apparent from the following detailed description, the accompanying drawings, and the appended claims.

### BRIEF DESCRIPTION OF THE DRAWINGS

FIG. 1 is a schematic illustration of the vegetable parchment of the present invention used as a weed barrier.

### DETAILED DESCRIPTION OF THE PREFERRED EMBODIMENTS

The vegetable parchment of the present invention has a high tensile strength and a high burst strength, which aids in providing an effective barrier to weeds. In addition, the parchment has a sufficient porosity to allow water and air to permeate the parchment and allow proper growth of the plants or seedlings to be cultivated. It has been found that use of the vegetable parchment results in enhanced growth of seedlings in comparison with seedlings which did not utilize the parchment, which is believed to be partially due to the hydroscopic nature of the parchment.

The preferred vegetable parchment for use in the present invention has a basis weight of approximately 20 to 60 lbs/3000 sq. ft. Most preferred for use in the present invention are 27# Black Genuine Vegetable Parchment or 35# Black Genuine Vegetable Parchment, both available from the West Carrollton Parchment Company. The 35# grade parchment has a slightly higher thickness than the 27# grade parchment, and is preferred for use due to its increased strength. The parchment preferably has a thickness ranging from about 1.5 mil to about 6.5 mil.

The parchment may be provided in the form of rolls, sheets, or it may be die cut into desired shapes. The vegetable parchment used in the present invention is prepared by a process in which a waterleaf grade paper is passed through a bath of sulfuric acid under prescribed time, temperature, and acidic conditions. The sheet is then rinsed to remove the sulfuric acid and is dried and rewound. A preferred process is described in commonly-assigned U.S. Pat. No. 5,916,666, which is incorporated herein by reference.

The tensile strength of the resulting parchment is greater than about 15 lbf/inch. The dry burst strength of the parchment is greater than about 10 lbs/sq. inch, and the wet burst strength is greater than about 4 lbs/sq. inch.

While black parchment is preferred for use, it should be appreciated that any other colored parchment may also be used as long it prevents new germination and weed growth.

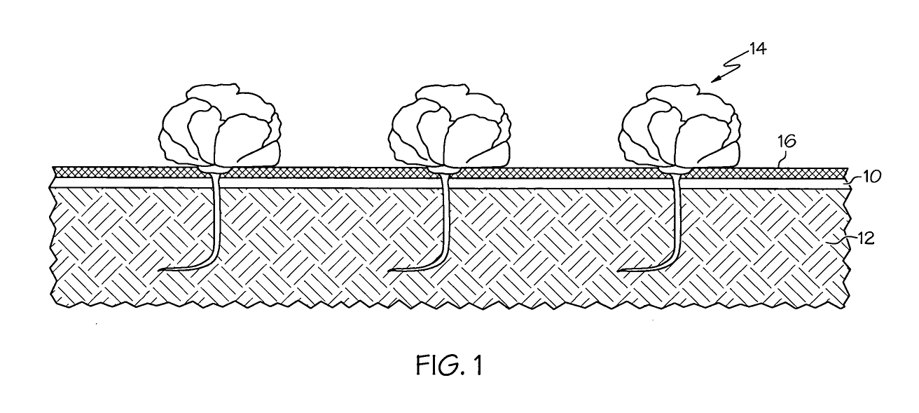

Referring now to FIG. 1, the application of the vegetable parchment is illustrated. As shown, the parchment 10 is preferably placed on top of soil 12 and around a plant or seedling 14 to be cultivated. In landscaping areas, mulch 16 may be applied on top of the parchment. The parchment may easily be torn to fit around shrubs and flowers without the use of any cutting devices which are normally required with the use of other weed control substrates.

In order that the invention may be more readily understood, reference is made to the following examples of compositions within the scope of the present invention, which examples are intended to be illustrative of the invention, but are not intended to be limiting in scope.

### EXAMPLE 1

Vegetable parchment in accordance with the present invention was tested for its ability to function as a weed barrier. Two different vegetable parchment grades were used for testing. One grade was 35# Black Genuine Vegetable Parchment and the other grade was B27G (a bleached parchment including a sorbic acid application), both available from West Carrollton Parchment Company.

Twelve pots were used for testing, each of which contained fescue grass seedlings. Two pots were control pots with no parchment applied. Two pots utilized a half section of black vegetable parchment paper. Two pots utilized a half section of B27G. Three pots were fully covered with 35# black vegetable parchment paper, and three pots were fully covered with B27G. All 12 pots were exposed to the same temperatures (72 to 77° F.), given equal amounts of water, and exposed to equal amounts of light.

It was noted that the pots which utilized half sections of parchment demonstrated expedited growth of grass compared to that of the control pots. It was further noted that exceptional growth occurred on the outer bands of the pots which were fully treated with black vegetable parchment.

Having described the invention in detail and by reference to preferred embodiments thereof, it will be apparent that modifications and variations are possible without departing from the scope of the invention.

What is claimed is:

1. A weed barrier comprising a porous, biodegradable vegetable parchment, said parchment having a tensile strength of between about 15 to about 120 lbf/inch, a dry burst strength of between about 10 and about 90 lbs/sq. inch, and a wet burst strength of between about 4 and about 60 lbs/sq. inch.

2. The weed barrier of claim 1 wherein said vegetable parchment has a basis weight of between about 20 to about 60 lb/3,000 sq. ft.

3. The weed barrier of claim 1, wherein said vegetable parchment is in contact with soil and adjacent a plant or seedling to be cultivated.

4. The weed barrier of claim 1 wherein said vegetable parchment is black in color.

5. The weed barrier of claim 1 wherein said vegetable parchment is hydroscopic.

6. A method of controlling weed growth comprising:
providing a porous, biodegradable vegetable parchment;
placing the vegetable parchment in contact with soil and adjacent a plant or seedling to be cultivated such that the growth of weeds through said vegetable parchment is prevented or substantially reduced.

7. The method of claim 6 wherein said vegetable parchment is placed between a layer of soil and a layer of mulch.

8. The method of claim 6 wherein said parchment has a tensile strength of between about 15 to about 120 lbf/inch, a dry burst strength of between about 10 and about 90 lbs/sq. inch, and a wet burst strength of between about 4 and about 60 lbs/sq. inch.

9. The method of claim 6 wherein said vegetable parchment has a basis weight of between about 20 to about 60 lb/3,000 sq.ft.

10. The method of claim 6 wherein said vegetable parchment has a porosity of between about 60 s to about 2000 s.
